(19) United States
(12) Patent Application Publication
(10) Pub. No.: US 2017/0272151 A1
(43) Pub. Date: Sep. 21, 2017

(54) Gigabit Ethernet Analyzer for Optical Time Domain Reflectometer

(71) Applicants: Frank Giotto, (US); Ross Emery, (US); Raymond Wertz, (US); Christopher Indolfi, (US)

(72) Inventors: Frank Giotto, New Hartford, NY (US); Ross Emery, Rome, NY (US); Raymond Wertz, New York Mills, NY (US); Christopher Indolfi, Rome, NY (US)

(21) Appl. No.: 15/072,533

(22) Filed: Mar. 17, 2016

(51) Int. Cl. H04B 10/071; H04B 10/2513; H04B 10/079

(52) U.S. Cl. CPC H04B 10/071; H04B 10/07951; H04B 10/2513

(57) ABSTRACT

This invention relates to a fiber optic fiber testing device presented in an app that compares three fiber link parameters against a table of specifications required in order for that fiber to transmit data at a particular speed. The invention presents a convenient ‘Pass’ or ‘Fail’ result for each parameter tested that immediately verifies whether the fiber being tested will meet the minimum basic criteria for transmission of data at a particular bandwidth speed, in accordance with that particular fiber manufacturer's specifications.

### FIELD OF THE INVENTION

The present invention relates generally to the field of fiber optic cables and test equipment and, more particularly, to a special app feature on an optical time domain reflectometer that provides the user with an easy to use interface outputting more efficient pass/fail results specifically relating to bandwidth speed capability, as this Gigabit Ethernet Analyzer factors in the specific fiber type being tested with references to that particular fiber manufacturer's specifications, and displays the distance, attenuation, and reflection results in user-friendly tables and graphs, providing the user with immediate and clear test results.

### BACKGROUND OF THE INVENTION

The Optical Time Domain Reflectometer (OTDR) allows for the measurement of light loss, fiber length, and optical return loss (OLR) of fiber optic cables during installation, repair, and verification. An OTDR is used on both Multimode and Singlemode style fiber optic cables. An OTDR is an optoelectric device that injects pulses of light into a fiber optic cable and analyzes the reflections created. The light passes through the fiber, and reflects back off impurities in the fiber (Rayleigh Backscatter), or major reflections (Fresnel Reflections), found at splice or break locations. The amount of time it takes for the pulse of light to be transmitted, reflect at the point of anomaly and return to the OTDR is precisely measured to obtain desired test results. These test results will enable the user to determine where any anomalies in the fiber lie, aiding in discovering where any splices, breakage, or other light losses in the fiber may occur.

The OTDR can also be fitted with optional accessories such as Power Meters, Visual light Sources, Ethernet testers, etc. to make the device more effective when characterizing an optical fiber. These accessories assist cable installers to ensure that the cable is installed correctly, and ensure that the cable abilities satisfy values set by manufacturers for bandwidth rates. This is important as the fiber contained in the cable must perform to the fiber manufacturer's minimum specification requirements. Meeting today's megabit and gigabit data transmissions rates requires that the correct fiber choice be made and the correct installation techniques be used because that determines whether the light loss and ORL specification meet those set by the fiber manufacturer. Most importantly, there is a maximum fiber length requirement set for each data rate parameter that must be measured and compared.

Therefore, there is a need in the fiber optic cable testing field to provide a testing device within an OTDR that has the ability to compare the major fiber link parameters against pre-loaded tables of specifications for each fiber type and manufacturers of fiber, which yields immediate, clear to read, Pass or Fail results. The Pass or Fail results will determine if the user will be able to transmit the data rates required over the installed fiber, as mandated by their transmission equipment.

### BRIEF SUMMARY OF THE INVENTION

In accordance with the present invention, there is provided . . . a Gigabit Analyzer, an application which may be installed in OTDR's, which enables the user to obtain Pass or Fail results for three criteria of a fiber cable—distance, attenuation, and ORL—depending upon the bandwidth speed being tested for and the maximum specification values allowed for by the fiber manufacturer. The Gigabit Analyzer application is pre-loaded with a table of distances, attenuations, and back reflection values for each of the major fiber types from all of the major fiber vendors. The objective is the ability to instantly qualify bandwidth speed and support that with a report detailing the results of testing. This is achieved without having to take the time to find the original manufacturer's specifications, as it is easily accessed through the invention's interface. This is especially important in environments and installation locations where it may be difficult for the user to quickly obtain these criteria. The OTDR technician's job is made simpler, while providing greater accuracy.

With the Gigabit Analyzer application, the user performs a test by attaching the fiber under test to the OTDR using the standard OTDR port. The user then follows the easily operated menus on the OTDR screen for inputting the fiber type to be tested, the manufacturing company of the fiber, and then what bandwidth speed criteria they need to test against. A simple press of a button provides results on the screen and in report form. The user presses the green Test button to view the results. If the distance, attenuation, and back reflection results all meet the fiber specifications provided by the fiber manufacturer for that particular bandwidth being tested, the application will present a clear ‘Pass’ result. If any one or more of the criteria fail to be met, the application will yield an overall ‘Fail’ result. Along with this ‘Fail’ indicator, the application will display what specific criteria limit was not achieved.

If this test evaluation receives a ‘Pass’ result for all three fields, this signifies that the cable is a candidate for transmitting the tested bandwidth speed based upon the fiber manufacturer's specifications.

This invention will enable fiber optic cable users to easily assess three measurements of fiber optic cable to determine whether the cable meets the minimum basic criteria for achieving a given bandwidth.

It would be advantageous to provide . . . an app as part of an OTDR that has the capability to process results for each of the three events—distance, attenuation, and reflection.

It would also be advantageous to provide . . . an app as part of an OTDR that compares these three results against an optimum specification provided by the fiber manufacturer of that specific fiber being tested.

It would also be advantageous to provide . . . pre-loaded specifications from the most common fiber manufacturers in an OTDR.

It would further be advantageous to provide . . . an app as part of an OTDR that states separate ‘Pass’ or ‘Fail’ results for the desired bandwidth capability of the fiber using the pre-loaded fiber manufacturer specifications.

It would also be advantageous to provide . . . an app as part of an OTDR that clearly shows the user what specific criteria passed or failed testing for the bandwidth capability being tested.

It would further be advantageous to provide . . . an app as part of an OTDR that has the ability to test other protocols different from Ethernet.

It would also be advantageous to provide . . . an app as part of an OTDR that provides the user the ability to set their own pass/fail criteria.

It would further be advantageous to provide . . . an app as part of an OTDR that allows the user to collect and document all test results, and to save this data in different formats to be used at later time.

### BRIEF DESCRIPTION OF THE DRAWINGS

A complete understanding of the present invention may be obtained by reference to the accompanying drawings, using the Firecat II OTDR as an example, when considered in conjunction with the subsequent, detailed description, in which:

### BRIEF DESCRIPTION OF DRAWINGS

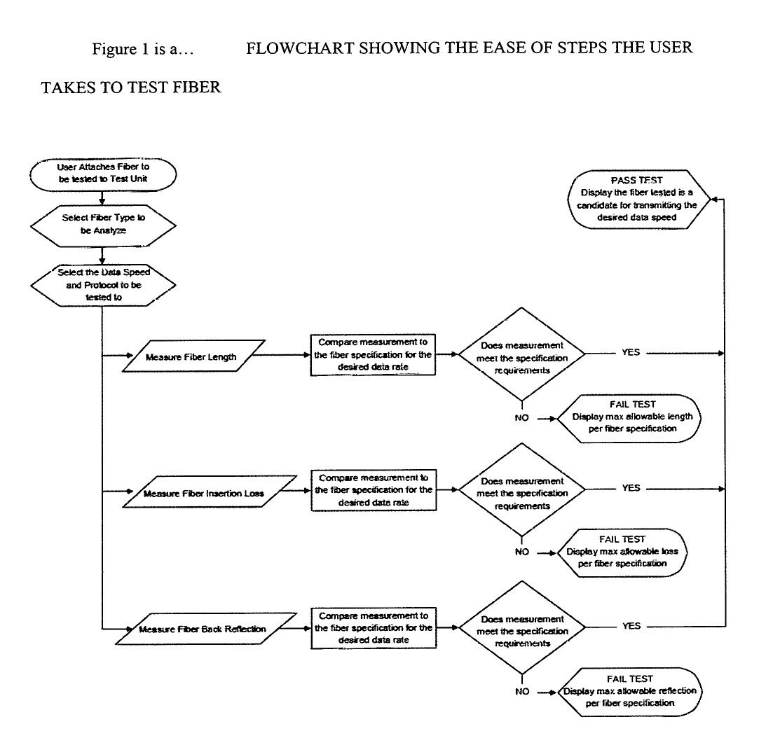

FIG. 1 is a flowchart displaying the ease of use of the steps the user takes in order to test and evaluate the specifications of the fiber.

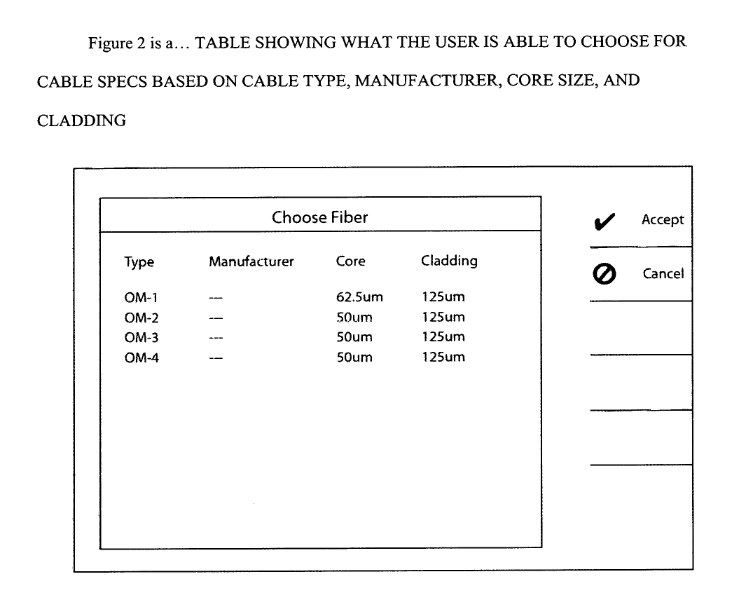

FIG. 2 is a sample showing of the application's screen prompting the user to choose a fiber cable type, the manufacturer of that fiber, the core size, and the cladding size.

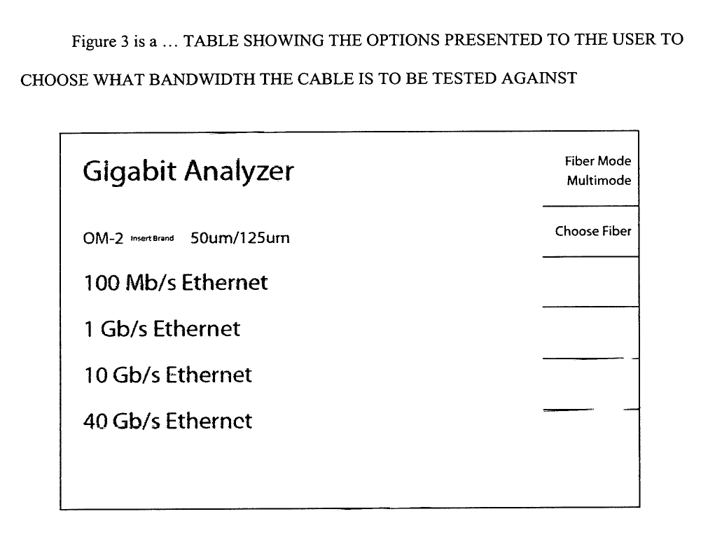

FIG. 3 is a sample showing of the application's screen prompting the user to choose what gigabit speed to test the fiber cable against.

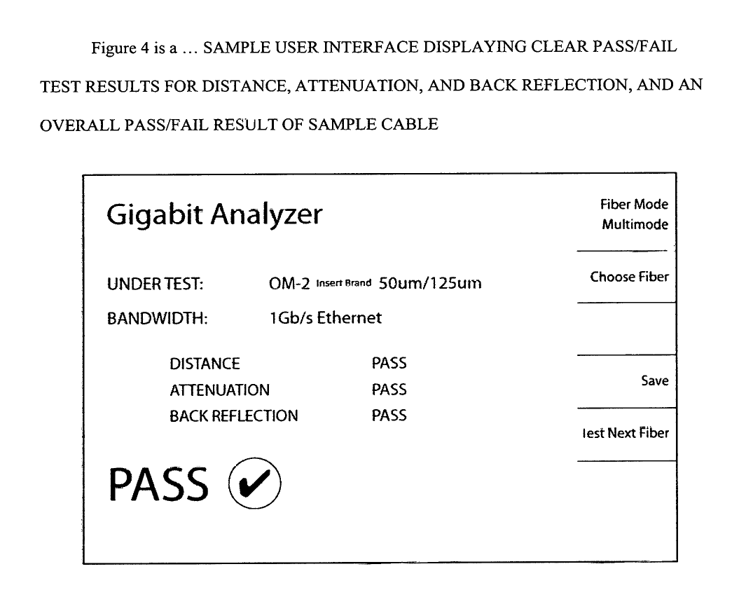

FIG. 4 is a sample showing of the app's screen that displays the results of the OTDR testing.

### SPECIFICATION OF DRAWINGS

FIG. 1 . . . is a flowchart displaying the ease of use of the steps the user takes in order to test and evaluate the specifications of the fiber. The user simply attaches the fiber cable to the OTDR for testing, selects the fiber type that is going to be analyzed, and selects the data speed and protocol that the cable is to be tested to. The app utilizes the pre-loaded information, and the OTDR's length, attenuation, and optical return loss (ORL) measurements to determine whether the fiber will pass or fail the manufacturer's specifications set for that particular fiber and the desired data rate. The app will display a “Pass or “Fail” test result for distance, attenuation, and optical return loss, enabling the user to easily determine whether the fiber they are working with has the ability to support the desired data speeds.

FIG. 2 . . . is a sample showing of the app's screen that prompts the user to choose a fiber cable type, the manufacturer of that fiber, the core size, and the cladding size. This information can be quickly entered and will enable the app to test against that specific manufacturer's cable specifications.

FIG. 3 . . . is a sample showing of the app's screen that prompts the user to choose what gigabit speed to test the fiber cable against. This screen enables the user to determine whether the fiber cable will support the desired gigabit speed.

FIG. 4 . . . is a sample showing of the app's screen that displays the results of the OTDR testing. FIG. 4 is an example of what the app screen would display if the cable passed all three tests—distance, attenuation, and back reflection—and satisfied the manufacturer's specifications to meet that particular bandwidth speed. This also shows the ability to save the test results within the app for later viewing. FIG. 4 demonstrates the clarity and simplicity with which the app displays these test results.

### DETAILED DESCRIPTION OF THE PRESENT INVENTION

The Gigabit Ethernet Analyzer is an application which may be incorporated in numerous devices, for example in an OTDR or a power meter and light source, or any fiber optic test equipment that measures distance, attenuation, and optical return loss (ORL) values.

App Launch Process/Steps User Takes: The app contains easily selectable settings to select fiber type and fiber manufacturer with desired data rate and protocols, for example, Ethernet and fiber link. The steps the user takes in order to perform the testing is seen in the flowchart of FIG. 1.

Information Loaded in OTDR App: The app is pre-loaded and contains all criteria that selected manufacturer publishes to meet minimal distance, attenuation, and ORL requirements to transmit defined data rate for protocol. App can be updated with additional manufacturing specifications as well through various means. One way to achieve this is by downloading additional specifications over the network. The cable specifications appear on the app screen as in FIG. 2, allowing the user to choose what manufacturer and cable type is being tested. FIG. 3 demonstrates the screen on which the user is able to choose what bandwidth to test against.

Information Derived from Testing: The app compares the measured values of distance, attenuation, and ORL produced by the OTDR and creates a pass/fail status for each, as well as a total overall pass/fail that is determined from those three criteria.

Ease of Viewing of Test Results: The app provides an output display of a “Pass” status for the fiber protocol and data rate tested provided that distance, attenuation, and ORL meet the manufacturer's minimum criteria for that particular fiber, as demonstrated in FIG. 4. Each criterion that failed is marked with a “Fail” status.

Ability to Save Data and Test Results: The app is capable of storing various data types. The ability to store and format test results in various formats for each individual fiber tested is provided to the user in a Qualification Report. The way in which this information is presented can be altered to suit user preferences. Since testing requires multiple fibers, the ability to identify each fiber tested and recall is made possible. The failed fiber may be repaired and a new test may be run. The new acceptable ‘Pass’ report can replace the old failed report in order to provide assurance to customers that the fiber does perform to acceptable qualifications.

1-9. (canceled)

10. In an optical time domain reflectometer (OTDR) of the type configured to have a port to attach to an optical fiber and to impose a light pulse onto the fiber and measure the time and amplitude of light reflected back along the fiber and thereby measure distance (length) of the fiber, attenuation of the light along the fiber, and optical return loss (ORL) of the fiber, said OTDR having a display screen to display test results of said fiber; the improvements wherein the OTDR includes data memory, said memory being pre-loaded with a table of acceptable distance, attenuation, and ORL values for each of a multiplicity of fiber types of a plurality of optical fiber manufacturers; a mechanism to permit a user to call up from said table and display a selected one of said fiber types, and display the fiber type on said screen; and a program functionality that matches distance value, attenuation value and optical return loss value measured by said OTDR for said optical fiber with manufacturer's acceptable values, in said stored table, of distance, attenuation and optical return loss corresponding to the selected fiber type; and providing a PASS indication on said display screen when said measured values satisfy said stored values; and providing a FAIL indication on said screen when one or more of said measured values fails to satisfy the corresponding stored value.

11. The OTDR of claim 10, wherein, when said program functionality provides said FAIL indication on said screen, the program functionality also displays on said screen which of said measured values fails to satisfy the corresponding stored value.

12. The OTDR of claim 10, wherein said data memory of said OTDR is adapted for storing measured value results of each test as well as said pre-loaded table of acceptable distance, attenuation, and return loss data for the selected fiber type.

13. The OTDR of claim 10, wherein the stored values in said pre-loaded table of acceptable distance, attenuation, and return loss data are technical data defining critical minimums as established from manufacturers of said cable types.

14. The OTDR of claim 10, wherein said program functionality in the OTDR presents on said screen thereof an input key for the user to choose the fiber manufacturer and fiber type, and an input key to select bandwidth capacity to be tested for the optical fiber.
